(19) United States
(12) Patent Application Publication
(10) Pub. No.: US 2019/0116854 A1
(43) Pub. Date: Apr. 25, 2019

(54) Atmospherically Fried Crisps, Equipment and Method for Making Same

(71) Applicant: Frito-Lay North America, Inc., Plano, TX (US)

(72) Inventors: Ajay Rajeshwar Bhaskar, Allen, TX (US); Richard James Ruegg, Frisco, TX (US); Leslie Scott Sullivan, Frisco, TX (US)

(21) Appl. No.: 16/226,493

(22) Filed: Dec. 19, 2018

Related U.S. Application Data
(63) Continuation-in-part of application No. 15/629,425, filed on Jun. 21, 2017.

(51) Int. Cl. A23L 19/18; A23L 19/00

(52) U.S. Cl. CPC A23L 19/18; A23L 3/32; A23L 19/03

(57) ABSTRACT

Raw fruits or vegetables are pre-treated prior to atmospheric frying. Pre-treatment includes application of a pulsed electric field to the raw products followed by slicing and immediate blanching in a water solution of above 160° F. in a turbulent environment. The pulsed electric field utilizes vertically oriented electrodes to treat the products. The treated food products can then be atmospherically fried at a low oil temperature to a shelf stable moisture content to produce fried crisps having an appealing light color and crunchy texture despite a high amount of reducing sugars, sucrose, starch, and/or solids present in the raw material.

This application is a continuation-in-part of U.S. patent application Ser. No. 15/629,425, filed Jun. 21, 2017, which is expressly incorporated herein by reference.

### TECHNICAL FIELD

Fried crisps, equipment and method for making same is described herein. More specifically, this description relates to a pulsed electric field and method for preparing fried crisps from fruits or vegetables.

### DESCRIPTION OF RELATED ART

Some fruits and vegetables are often difficult to subject to frying processes in the production of shelf stable snack foods. For example, produce comprises high amounts of reducing sugars, sucrose, starch, and/or solids may be difficult to fry to a shelf stable moisture content without significant burning.

Sweet potatoes are rich in fiber, protein, vitamins, minerals, starch, and antioxidants. However, due to their high reducing sugar content and acrylamide (>1000 ppb) levels following dehydration, their use in snack foods has been limited to vacuum frying technology, which is not always economically feasible. Conventional frying process are generally limited to use of only fresh produce and result in highly variable acrylamide contents, ranging from 500-2,000 ppb, for example, and diminished orange coloring. Thus, they are difficult to fry atmospherically to a shelf stable moisture content as they turn dark at around 2.5% moisture content. There is a need for an alternate solution to process these such produce without the high costs of vacuum frying and without the variability and inconsistent product resulting from conventional frying. In particular, given the popularity of kettle cooked potato chips, there is a need for a solution that produces the kettle cooked products' crisp sensation with a consistently appealing look and taste.

### SUMMARY OF THE INVENTION

Provided herein are ready-to-eat fried crisps manufactured directly from raw sliced fruits or vegetables (i.e., produce). The crisps are shelf-stable and light in color despite the reducing sugar content present in the raw produce.

Below is a simplified summary of this disclosure meant to provide a basic understanding of some aspects of the products and methods described herein. This is not an exhaustive overview and is not intended to identify key or critical elements or to delineate the scope of the description. Its sole purpose is to present some concepts in a simplified form as a prelude to the more detailed description below.

In one aspect, disclosed herein is a method for making produce crisps comprises the steps of applying a pulse electric field to a plurality of raw whole produce in a pulsed electric field treatment chamber, the treatment chamber comprising a treatment space between a negative and a positive electrode, the negative and positive electrodes oriented in a vertical configuration; slicing the pulsed produce into slices; immediately blanching the slices in a water solution at a temperature of above 145° F. to form blanched produce slices; and frying the blanched produce slices to form a plurality of produce crisps with a shelf stable moisture content and an oil content of between about 28% to less than 44%.

In another aspect, a pulsed electric field treatment chamber comprises: an inner chamber comprising a predetermined water solution level; an upper conveyor belt having at least its bottom surface below the predetermined water solution level; a lower conveyor belt entirely below the predetermined water solution level; and a negative electrode opposite a positive electrode on either side of the lower conveyor belt, the negative electrode and the positive electrode oriented vertically and the negative electrode fully submerged within the predetermined water solution level, wherein said chamber is configured to provide a pulsed electric field to a treatment space between the bottom surface of the upper conveyer belt and a top surface of the lower conveyor belt, and between the negative electrode and the positive electrode.

Other aspects, embodiments and features of the invention will become apparent in the following written detailed description and accompanying drawings.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a flow chart of one embodiment for making a shelf-stable produce crisps as described herein;

FIG. 2A depicts an internal view of a pulsed electric field treatment chamber in one embodiment as described herein;

FIG. 2B depicts a cutaway view of the pulsed electric field treatment chamber of FIG. 2A;

FIG. 3 depicts passage of the raw whole produce through a treatment space between the vertically oriented electrode configuration according to one embodiment;

FIG. 4 is an illustration depicting a comparison between the resulting textures of an un-treated produce product versus one that is treated by the pulsed electric field application described herein;

FIG. 5 is a graphical representation showing the comparative levels of resulting oil contents using different treatments; and

FIG. 6 is a graphical representation showing the comparative amounts of acrylamide levels with and without the treatment described herein.

### DETAILED DESCRIPTION OF THE INVENTION

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The terms “including,” “comprising,” “having,” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. As used herein, “up to” includes zero, meaning no amount (i.e., 0%) is added in some embodiments. The term “immediately” means as soon as practicable, without any intervening step(s).

As used herein, produce refers to fruits and/or vegetables grown by farming. In one embodiment, produce refers to root vegetables comprising solids in an amount between about 10% to about 40%. In one embodiment, produce refers to root vegetables comprising solids in an amount greater than about 30% by weight of the produce. In one embodiment, produce refers to root vegetables comprising solids in an amount between about 30% to about 40% by weight of the produce. In one embodiment, produce refers to root vegetables comprising solids in an amount between about 10% to about 25% by weight of the produce. In one embodiment, produce refers to root vegetables comprising solids in an amount between about 10% to about 20% by weight of the produce. In one embodiment, the raw produce for use with the method and product described herein comprises a high reducing sugar concentration of greater than about 0.05% to about 4.0%. In one embodiment, the sucrose content is greater than about 1% and up to about 6%. In one embodiment, the produce may comprise one or more of sweet potatoes, apples, beets, carrots, pumpkins, parsnips, taro root, and yucca.

In one embodiment, the produce consists of sweet potatoes. With further regard to the above challenges of processing produce such as sweet potatoes, the sugar profile of raw sweet potatoes (prior to treating steps described herein) should be noted. Though their name might imply otherwise, sweet potatoes are actually very different from white potatoes Though they have in common the presence of reducing sugars—glucose, sucrose and fructose, the sugar profile of sweet potatoes versus white flesh potatoes is actually so different that sweet potatoes cannot be expected to behave in the same way as regular, or white, potatoes. Indeed, sweet potatoes pose more challenges in their processing due to the different sugar profile. The content of sucrose is roughly ten times higher in sweet potatoes than in white potatoes. By way of example, raw white chipping potatoes comprise an amount of about 0.1% reducing sugars and about 0.05% sucrose, whereas sweet potatoes contain between 1% to 6% sucrose. Sweet potatoes are also high in beta-amylase and high in glucose. Thus, processes involving dehydration to shelf stable moisture contents are more challenging for sweet potatoes. Color in sweet potatoes is not only subject to Maillard reactions but also further influenced by caramelization, a type of non-enzymatic browning, and is not fueled by the presence of amino acids unlike Maillard browning. Table 1 reflects the caramelization temperatures of the reducing sugars in sweet potatoes.

TABLE 1
Caramelization Temperatures of Reducing Sugars

| Sugar | Caramelization Temp |
|---|---|
| Fructose | 110° C., 230° F. |
| Galactose | 160° C., 320° F. |
| Glucose | 160° C., 320° F. |
| Maltose | 180° C., 356° F. |
| Sucrose | 160° C., 320° F. |

Brown pigments generated through the caramelization process can be controlled by the process described herein using a low temperature frying profile as described below. Using the process described herein, all sugars are reduced by roughly 50%, regardless of the particular variety of sweet potato. All sugars are affected equally and observe a proportional reduction using the method described herein.

Several embodiments for snack foods described herein and methods for making same will now be described with reference to the figures. Unless otherwise noted, like elements will be identified by identical numbers throughout all figures.

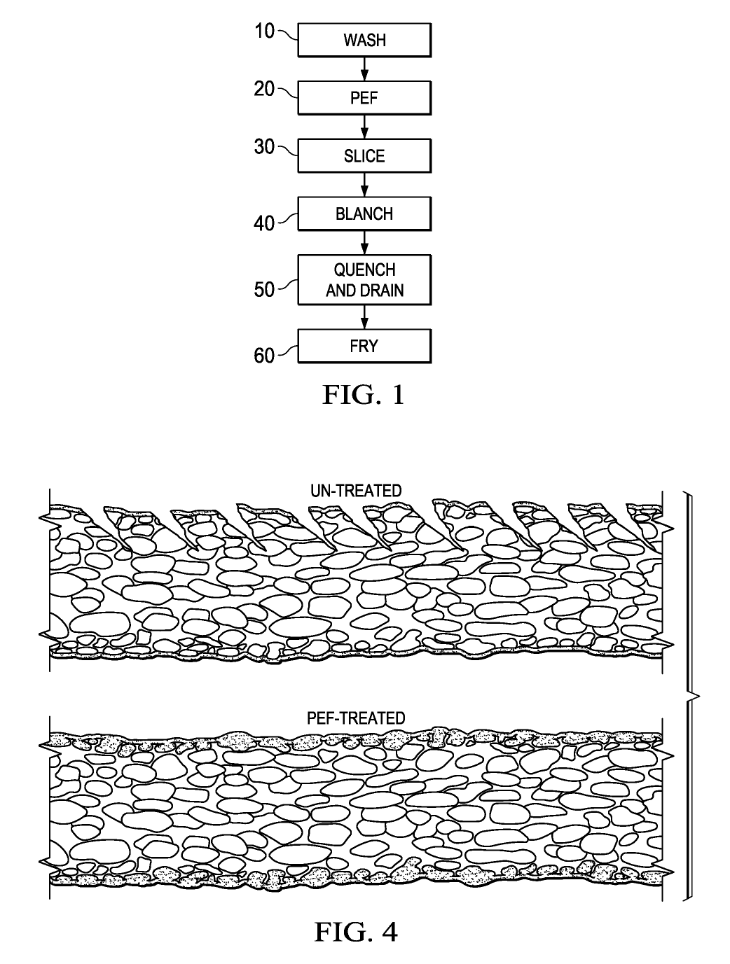

One embodiment of the method described herein will now be discussed with reference to FIG. 1. FIG. 1 is a flow chart of one embodiment for making shelf-stable fried crisps as described herein. It should be noted that this figure is for illustrative purposes and is not meant to be limiting unless otherwise indicated. Some embodiments may comprise all the steps shown in FIG. 1, while others may omit washing and/or rinsing steps shown in FIG. 1.

With reference to FIG. 1, the method for making produce crisps as described herein comprises a first step 10 of washing whole raw produce to remove any dirt or foreign objects that may have attached to the produce. Suitable washing solutions comprise, for example, water at room temperature or a freshwater solution comprising an anti-foaming agent. In certain embodiments, the washing solution is free of salts. In some embodiments, the washing solution consists of water. Such step may not always be necessary. The produce may be optionally sized after washing. In some embodiments, the produce is peeled. In some embodiments, the produce is sliced to a length no greater than about 4 inches. In some embodiments, the produce remains unpeeled having its peel, rind, skin, and inside cellular material or flesh intact.

After washing 10 but before any slicing, the whole raw produce is subjected to a pulsed electric field (“PEF”) 20 to enhance mass transfer. Electroporation enables the extraction of intracellular substances from the cells of the raw produce. The treatment chamber is arranged to receive the produce in solid phase, with a liquid transport carrier, past at least two electrodes, where the pulse generator is arranged to apply a PEF to a treatment space between the electrodes. In one embodiment, the process is continuous and raw whole produce is conveyed on a conveyor belt system to and through the PEF equipment, where the treatment space receiving the PEF is across a portion of a conveyor belt submerged in the liquid transport carrier. During test runs, a 30-kV unit was used at a repetition rate of 300 Hz at 12 feet/minute.

In one embodiment, the applied electric field is a pulsed electric field in the form of rectangular or (exponential) mono polar (bipolar) pulses. In one embodiment, the whole raw produce is subjected to an electric field strength of at least about 0.8 kV/cm. In one embodiment, the whole raw produce is subjected to an electric field strength of between about 0.8 to about 3.0 kV/cm. In one embodiment, the electric field strength ranges from about 1.1 to about 2.0 kV/cm. In one embodiment, the electric field strength ranges from about 1.5 to about 2.2 kV/cm. In one embodiment, about 1,000 pulses per second are applied. In one embodiment, the number of pulses applied is between about 70 to about 80.

Based on data on the frequency dependency of conductivity of intact and permeabilized plant tissues, a coefficient Zₚ, designated the disintegration index, was used to determine a suitable PEF treatment level. A Zₚ value, or disintegration index, of about 0.2 to about 0.35 is used herein and may be determined using the following formula:

Zₚ=1−b*[(K′ₕ−K′ₗ)/Kₕ−Kₗ)]; b=Kₕ/K′ₕ; 0≤Zₚ≤1

Where Kₗ, K′ₗ=electrical conductivity of untreated and treated materials, respectively, in a low-frequency field (1-5 kHz); Kₕ, K′ₕ=electrical conductivity of untreated and treated materials, respectively, in a high-frequency field (3-50 MHz). For intact cells, Zₚ=0; for total cell disintegration, Zₚ=1.

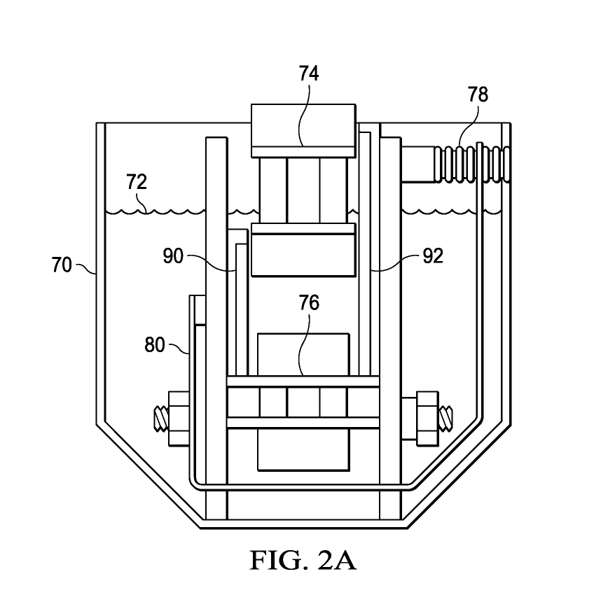

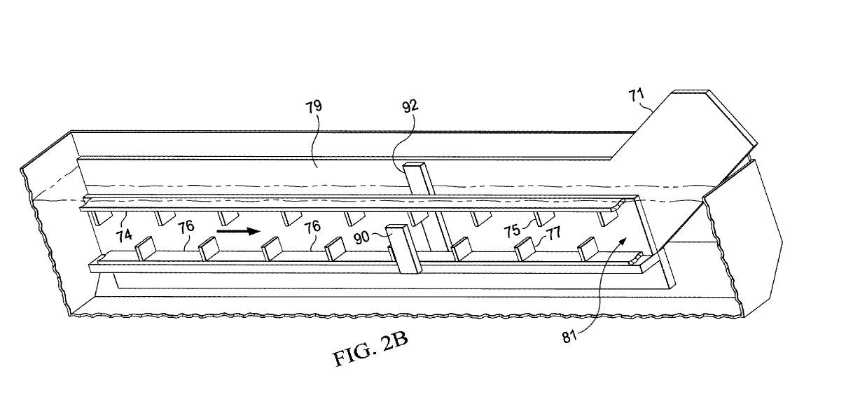

FIGS. 2A and 2B show one embodiment of a PEF treatment chamber 70 through which produce is treated according to the above described method of FIG. 1 to provide consistent z-value data and desirable crisp products. The unit 70 is comprised of stainless steel tub with sidewalls 71 comprising sidewall insulators 79 around an inner chamber that comprises a predetermined water solution level 72, an upper conveyor belt 74 above the predetermined water solution level 72, a lower conveyor belt 76 below the predetermined solution water level 72, and a vertically oriented electrode configuration 90, 92 on opposing sides of a top surface of the lower conveyor belt 76. Stainless steel walls 71 support the belting and the drives while the inner chamber around the electrodes comprises polymer insulators of ultrahigh molecular weight. The vertically oriented electrode configuration comprises a positive electrode 92 and a negative electrode 90, the negative electrode 90 fully submerged beneath the predetermined water solution level 72. The predetermined amount is a sufficient amount such that at least the bottom of the top conveyor is submerged within the water solution. The chamber unit 70 is configured to provide or apply a pulsed electric field to a treatment space between the negative electrode 90 and the positive electrode 92, and between a bottom surface of the upper conveyor belt 74 and a top surface of the lower conveyor belt 76.

Raw produce is fed into the unit 70 below the upper conveyor belt 74, above the lower conveyor belt 76. Flights 75 on the upper conveyor belt 74 ensure that the produce remains below the predetermined water solution level 72 when the produce is moved by the upper conveyor belt 74 along the produce flow direction indicated by the arrow in FIG. 2B. Similarly, flights 77 on the lower conveyor belt 76 help ensure the produce flow continues to move in the produce flow direction. In one embodiment, the conveyor belts 74, 76 comprise plastic. In one embodiment, the plastic comprises an ultrahigh molecular weight plastic. In one embodiment, an electrode strap 80 is connected to the negative electrode and passes under the lower conveyor belt 76 to an electrical terminal 78, which is insulated from the sidewall of the tank. The terminal 78 may also connect to the positive electrode 92 such that current flows through the positive electrode 92 and down the equipment across the liquid or water level. During operation, the unit 70 may be closed to minimize electrical field interference and comply with safety mechanisms of the PEF chamber. In one embodiment, the positive electrode 92 is only partially submerged below the predetermined water solution level, while the negative electrode 90 is fully submerged. That is, the positive electrode 92 is longer than the negative electrode 90 and the lower ends of the electrodes 90, 92 are aligned at substantially the same depth in the water. The positive electrode is longer than the negative electrode in one embodiment and electrically connected above the predetermined water level 72. In such embodiment, the positive electrode extends above the predetermined water solution level, or out of the water solution. Air within the chamber 70 also acts as an insulator for the positive electrode 92. The inventors have found that the vertically oriented electrode configuration provides for an uninterrupted treatment space within the chamber 70 and provides a more localized field for consistent z-value data. In one embodiment, the positive electrode is substantially parallel to the negative electrode. As used herein, the term “substantially” refers to the complete or nearly complete extent or degree of an action, characteristic, property, state, structure, item, or result For example, the “substantially” parallel electrodes are either completely parallel or nearly completely parallel.

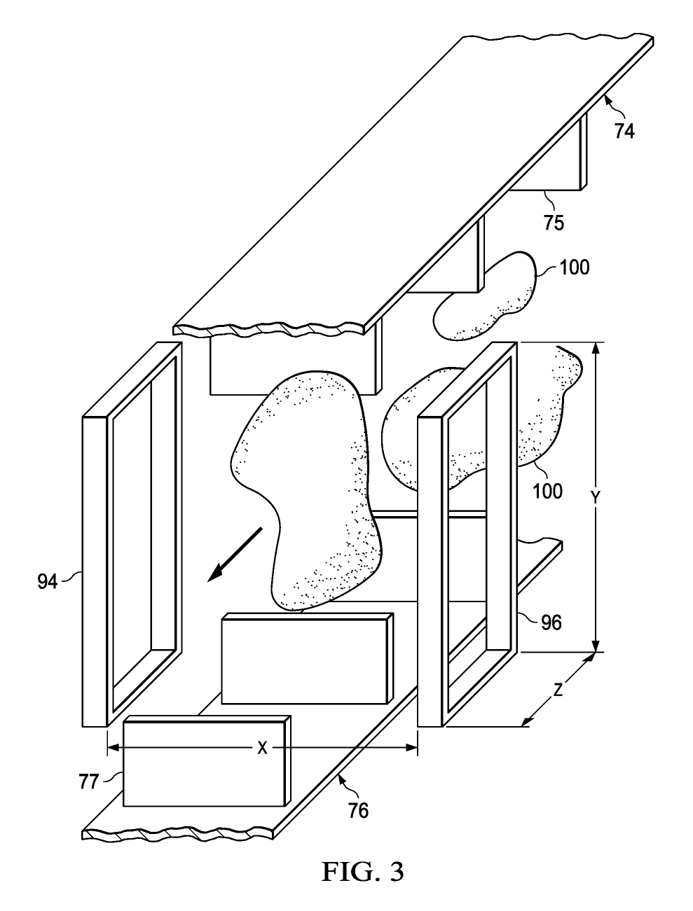

FIG. 3 depicts passage of the raw whole produce 100 through a treatment space between the vertically oriented electrode configuration according to one embodiment. In this embodiment, the positive and negative electrodes 94, 96 remain on either side of the dual belt system, however, the electrodes 94, 96 are of equal or substantially equal length. In one embodiment, the positive electrode is connected to the positive terminal via an insulated connector. One skilled in the art, armed with this disclosure, can determine the dimensions of the electrodes (i.e., treatment space) according to the size of the produce desired to be treated and the required range of applied electric field disclosed above. During successful test runs, the electrode width Z was about three inches, the electrode height Y was between about 3 to about 85 inches, and the electrode gap X was between about 3 to about 8 inches Increasing electrode width drops the field and may require a corresponding increase in generator power to apply the disclosed electric field.

With reference back to FIG. 1, following application of the pulsed electric field 20, the whole raw produce is then sliced 30. In one embodiment, the whole produce is sliced into slices comprising a thickness of less than about 0.1 inch. In one embodiment, the thickness is less than about 0.09 inch. In one embodiment, the thickness is between about 0.06 and about 0.08 inches. In one embodiment, the thickness is about 0.07 inch. At thicknesses outside the values and ranges disclosed herein, the slices will not dehydrate uniformly and the process will therefore result in a dense and chewy product. One skilled in the art armed with this disclosure can easily determine how to perform the slicing step 30.

Immediately after slicing 30 (i.e., without any intervening step following slicing), the slices are subjected to a blanching step 40 in a turbulent environment comprising continuous agitation with water and air injection, free of mechanical agitation. In one embodiment, blanching is performed at temperatures of above about 145° F. for less than about 6 minutes. In one embodiment, blanching is performed at temperatures of above about 160° F. In one embodiment, blanching is performed at temperatures of above about 160° F. and about 180° F. In other embodiments, blanching is performed at temperatures in a range of 160° F. and 175° F. In one embodiment, blanching is performed for between about 2 to about 5.5 minutes. In one embodiment, blanching is performed at between about 145° F. to about 195° F. for between about 1 to about 6 minutes. In one embodiment, blanching is performed at between about 160° F. to about 180° F. for between about 3 to about 4 minutes. Dense produce comprising higher amounts of starch may require longer blanching times. In certain embodiments, the blancher selected may comprise a rotary blancher with a substantially sealed housing and a water supply for injecting water or steam into the blancher to heat the blancher and maintain the temperature at the set point temperature. As used herein, a turbulent environment is one configured to keep slices separated during blanching. Slice agitation may be performed, for example, using a screw (e.g., auger) within a water chamber comprising a water recirculation rate configured to recirculate water to keep slices separated. During test runs, a rotary drum blancher and a blower manufactured by Lyco Manufacturing Inc.® was used.

In one embodiment, the blanching step 40 includes operating a rotary drum blancher including a screw to create a turbulent environment with continuous agitation of the slices. The blancher has a design throughput of between about 400 lbs/hr and about 1800 lbs/hr. The slices are separated into 8 flights within the blancher such that the mass per flight is between about 1.3 lbs and about 14.1 lbs. The blanching step for each flight is performed at between 160° F. and 175° F. for between about 1 and about 2 minutes. In one particular embodiment, the blanching step may be performed for about 1.5 minutes. In another particular embodiment, the blanching step may be performed for a duration of between 1.5 minutes and 3 minutes. The combination of the number of flights, temperature, blanching time, and throughput of the blancher creates a turbulent water solution with increased and continuous agitation of the slices during the blanching step.

Following the required blanching period and temperature, FIG. 1 depicts an optional quenching and draining step 50 prior to frying 60. Such quenching and draining step performs the function of water removal to improve frying efficiency in some embodiments. The frying step is an atmospheric frying step performed at a low inlet oil temperature of between approximately 280° F. to about 315° F. in one embodiment. In another embodiment, the inlet oil temperature may range from about 285° F. to about 295° F. In one embodiment, the inlet temperature is about 280° F. In one embodiment, the frying is performed for up to about 14 minutes. In one embodiment, the frying is performed for up to about 125 minutes. In one embodiment, the frying can be performed in as little as about 5 minutes. In one embodiment, the frying can be performed from about 5 to about 14 minutes. In one embodiment, the discharge oil temperature is between about 260° F. to about 290° F. In one embodiment, the discharge oil temperature is between about 270° F. to about 280° F. In one embodiment, the discharge oil temperature is about 275° F. to about 278° F. In one embodiment, the frying is performed until a finished moisture of between about 2% and about 3.5% is achieved. In one embodiment, the frying is performed until a finished moisture of between about 2.7% and about 3.3% is achieved. In one embodiment, the frying is performed until a finished moisture of about 2.5% is achieved.

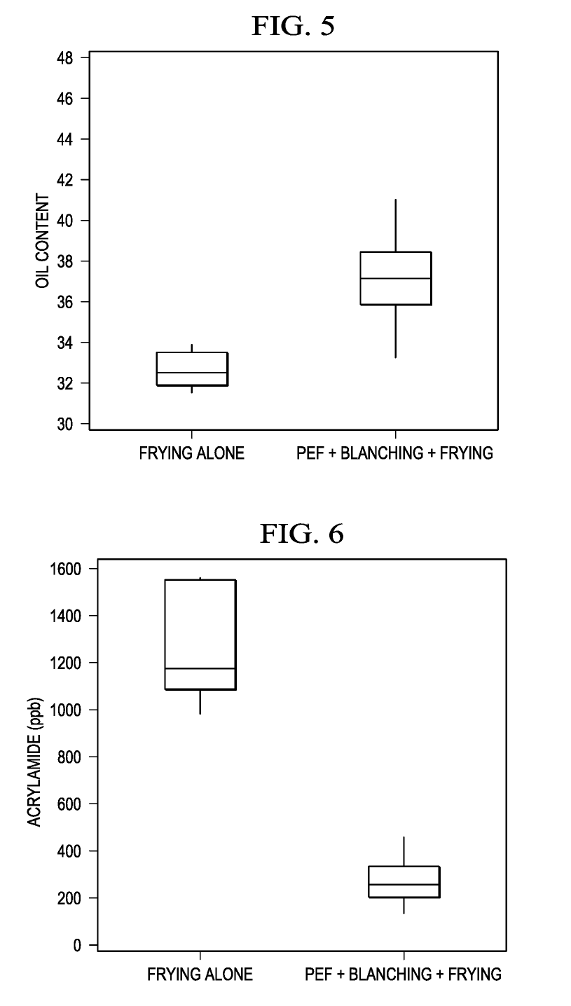

Finished fried product resulting from the above described method should comprise an oil content of about between about 30% and about 40%. In one embodiment, the finished fried product comprises an oil content of between about 32% and about 39%. In one embodiment, the finished fried product comprises an oil content of between about 35% and about 38%. In one embodiment, the finished fried product comprises an oil content of between about 38% and 39%. FIG. 5 is a graphical representation, for example, of comparative oil contents for an untreated atmospherically fried product versus product that underwent the PEF treatment followed by blanching as described herein. Unlike vacuum-fried produce, for which a dense and oily texture is obtained, the resulting fried crisp described herein is not as oily.

Subjecting the produce to the method described herein results in a number of benefits. Across several varieties of tested sweet potatoes, the process described herein consistently delivered acrylamide levels below 250 ppb. Comparative data for different treatments can be seen in FIG. 6. Moreover, both reducing sugars and sucrose are reduced in half using the method and equipment described herein, versus prior art frying processes without the pre-treatments described herein. Table 2 demonstrates the average amounts of reducing sugars (glucose, fructose) and sucrose during trial runs comparing untreated sweet potato crisps versus sweet potato crisps pre-treated using the method comprising the PEF and blanching steps in this description. Both high and low end values of the ranges for the reducing sugars and sucrose were lower for the pre-treated crisps than for the untreated crisps in all trial runs, the number of which exceeded 600.

TABLE 2
Average Reducing Sugars and Sucrose Across All Trials

| | Average Reducing | |
|---|---|---|
| | Sugars | Average |
| Process | (Glucose Fructose) | Sucrose |
| Untreated crisps | 1.01 | 4.1 |
| Pre-treated crisps | 0.51 | 2.6 |

FIG. 4 is an illustration comparing an un-treated cellular matrix material to a PEF treated material. The PEF treatment maintains cell wall integrity of the sweet potatoes, and thus, in combination with the below described blanching and frying steps, improves the texture to provide more crispness in the finished product. As depicted in FIG. 4, the treatments described herein result in a crust formation that contributes to an improved texture Textural data was obtained used a TA.XT2 Texture Analyzer The Three Point Bending Test was performed by supporting the sample horizontally with the probe moving down bending it at the center. As the specimen bends, it stores up strain energy, which at the point of fracture is dissipated as a cracking snap. The breaking upon the application of a force is a desirable textural property in most crisp foods. The puncture test was performed using a 5-mm diameter, flat-tip puncture probe. The test speed was 20 mm/sec with an aim of at least 30 measurements for each sample and each is punctured through the center of the chip. In one embodiment, the hardness ranges from between about 395 to about 800 grams peak force. In one embodiment, the hardness ranges from between about 435 to about 685 grams peak force. In one embodiment, the hardness ranges from between about 515 to about 615 grams peak force. Slice thickness for the product ranges from about 0.65 inches to about 0.80 inches. In one embodiment, the slice thickness for the product ranges from about 0.65 inches to about 0.75 inches. In one embodiment, the slice thickness for a plurality of packaged product comprises an average of about 0.7 inches.

In certain embodiments, ready-to-eat produce crisps made using the method and equipment described herein comprising or consisting of a coloring substantially equivalent to the coloring of the raw, untreated produce. In embodiments wherein the produce consists of sweet potatoes, for example, the resulting cooked crisps are sweet potato crisps substantially comprising a single color, the single color substantially the same as, or equivalent to, the natural color of the uncooked raw sweet potato. As used herein “substantially comprising a single color” means that only one single color within the base of the crisp is detectable to the naked, untrained eye. In some embodiments, though more than one gradation or shade of a color (i.e., hues) may be somewhat visible to the naked eye, the untrained eye will typically perceive a single color For purposes of describing the favorable coloring that can only be achieved with sweet potatoes as described herein, the color is described under the standards set forth by the Hunter Lab color space.

Hunter L, a, b color space is a three-dimensional rectangular color space based on Opponent-Colors Theory. “L” indicates lightness and “a” and “b” indicate the color-opponent dimensions, further described below, based on nonlinearly compressed (e.g. CIE XYZ) coordinates. C.I. is a prefix for a listing of colorants listed according to Color Index Generic Names and Color Index Constitution Numbers as established by the Color Index International (CIE), which is a reference database jointly maintained by the Society of Dyers and Colourists and the American Association of Textile Chemists and Colorists. Thus, the color scale values are used to define the darkness/lightness of the resulting crisps.

All colors can be represented in L, a, b rectangular color space. In general, Hunter Color “L” scale values are chambers of light reflectance measurement, and the higher the value is, the lighter the color is since a lighter colored material reflects more light. Generally, the “L” axis denotes the level of white/black, or lightness, where 0 is black, 100 is white and 50 is middle gray. For the “a” (red-green) axis, positive values are red, negative values are green, and 0 is neutral. For the “b” (blue-yellow) axis, positive values are yellow, negative values are blue, and 0 is neutral. In particular, in the Hunter Color system the “L” scale contains 100 equal units of division. Absolute black is at the bottom of the scale (L=0) and absolute white is at the top of the scale (L=100). The color gray can be represented by “L” values between 0 and 100 at a and b values of zero.

In embodiments consisting of sweet potato, resulting crisps comprise an L-value of about 34 to about 65. In one embodiment, the L-value is about 44 to about 58. In another embodiment, the L-value is about 48 to about 53. In one embodiment, the a-value is about 12 to about 30. In one embodiment, the a-value is about 16 to about 25. In one embodiment, the a-value is about 18 to about 22. In one embodiment, the b-value is about 15 to about 35. Table 3 indicates color values as determined using a D25Lt Colorimeter manufactured by HunterLab. Oil content and moisture percentages are also indicated for the resulting crisps

TABLE 3
Resulting characteristics of improved sweet potato crisps

| PEF + | | | | | |
|---|---|---|---|---|---|
| blanched | | | | Moisture | Oil |
| samples | L value | A value | B value | (%) | (%) |
| 1 | 47.29 | 19.66 | 27.85 | 2.78 | 31.59 |
| 2 | 42.18 | 20.42 | 24.10 | 1.94 | 43.60 |
| 3 | 46.87 | 18.48 | 27.68 | 2.60 | 42.37 |
| 4 | 42.51 | 18.07 | 25.08 | 2.67 | 33.99 |
| 5 | 44.04 | 15.81 | 25.22 | 2.57 | 36.32 |
| 6 | 44.59 | 20.69 | 25.83 | 2.87 | 43.02 |
| 7 | 41.41 | 19.56 | 23.93 | 2.13 | 45.16 |

Unless otherwise specified, all percentages, parts and ratios as used herein refer to percentage, part, or ratio by weight of the total. Unless specifically set forth herein, the terms “a”, “an”, and “the” are not limited to one of such elements, but instead mean “at least one,” unless otherwise specified. The term “about” as used herein refers to the precise values as indicated as well as to values that are within statistical variations or measuring inaccuracies.

The methods disclosed herein may be suitably practiced in the absence of any element, limitation, or step that is not specifically disclosed herein. Similarly, specific snack food embodiments described herein may be obtained in the absence of any component not specifically described herein. Thus, the crisps described herein may consist of those listed components as described above.

Concentrations, amounts, and other numerical data may be expressed or presented herein in a range format It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, the range 1 to 10 also incorporates reference to all rational numbers within that range (i.e., 1, 11, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed These are only examples of what is specifically intended and all possible combinations of numerical values between the lowest value and the highest value enumerated are to be considered to be expressly stated in this application in a similar manner.

While this invention has been particularly shown and described with reference to several embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method of making fried produce crisps, the method comprising the steps of:
applying a pulsed electric field to a plurality of raw whole produce in a pulsed electric field chamber,
slicing the pulsed raw whole produce to form a plurality of produce slices,
blanching each slice of the plurality of produce slices in a water solution at a temperature in a range of 160° F. to 180° F. for a duration of between 2 minutes to 5.5 minutes to form blanched slices, and
frying the blanched slices to form a plurality of fried produce crisps.

2. The method of claim 1, wherein blanching each slice of the plurality of produce slices in the water solution comprises blanching each slice of the plurality of produce slices in the water solution at a temperature in a range of 160° F. to 175° F.

3. The method of claim 2, wherein blanching each slice of the plurality of produce slices in the water solution comprises blanching each slice of the plurality of produce slices in the water solution for a duration of between 1.5 minutes and 3 minutes.

4. The method of claim 2, wherein blanching each slice of the plurality of produce slices in the water solution comprises blanching the plurality of produce slices immediately after slicing the pulsed raw whole produce.

5. The method of claim 1, wherein frying the blanched slices to form a plurality of fried produce crisps includes frying the blanched slices for up to about 14 minutes.

6. The method of claim 1, wherein each of the fried produce crisp of the plurality of fried produce crisps has a finished moisture content of less than about 3.5%.

7. The method of claim 1, blanching each slice of the plurality of produce slices in the water solution comprises operating a screw within a water chamber of a blancher to advance the plurality of produce slices through the blancher.

8. The method of claim 7, blanching each slice of the plurality of produce slices in the water solution comprises separating the plurality of produce slices into a number of flights within the blancher.

9. The method of claim 7, blanching each slice of the plurality of produce slices in the water solution comprises operating the blancher to create a turbulent environment for the plurality of produce slices.

10. A method of making fried produce crisps, the method comprising the steps of:
applying a pulsed electric field to a plurality of raw whole produce in a pulsed electric field chamber,
slicing the pulsed raw whole produce to form a plurality of produce slices,
operating a blancher to blanch each slice of the plurality of produce slices in a turbulent water solution at a temperature in a range of 160° F. to 175° F. for a duration of between 1.5 minutes to 3 minutes, and
frying the blanched slices to form a plurality of fried produce crisps.

11. The method of claim 10, wherein operating the blancher comprises separating the plurality of produce slices into a number of flights within the blancher.

12. The method of claim 11, wherein each flight of the number of flights has a mass of 1.3 lbs and 14.1 lbs.

13. The method of claim 11, wherein the number of flights is equal to eight.

14. The method of claim 11, wherein operating the blancher comprises operating a screw to advance the number of flights through the blancher within a water chamber of the blancher.

15. The method of claim 10, wherein operating the blancher comprises blanching the plurality of produce slices immediately after slicing the pulsed raw whole produce.

16. The method of claim 10, wherein frying the blanched slices to form a plurality of fried produce crisps includes frying the blanched slices for up to about 14 minutes.

17. The method of claim 10, wherein each of the fried produce crisp of the plurality of fried produce crisps has a finished moisture content of less than about 3.5%.

18. A method of making fried produce crisps, the method comprising the steps of:
applying a pulsed electric field to a plurality of raw whole produce in a pulsed electric field chamber,
slicing the pulsed raw whole produce to form a plurality of produce slices,
advancing the plurality of produce slices in a number of flights within a turbulent water solution at a temperature in a range of 160° F. to 175° F. for a duration of between 1.5 minutes to 3 minutes to form blanched slices, and
frying the blanched slices to form a plurality of fried produce crisps.

19. The method of claim 18, wherein advancing the plurality of produce slices in the number of flights comprises placing the produce slices within the turbulent water solution immediately after slicing the pulsed raw whole produce.

20. The method of claim 18, wherein advancing the plurality of produce slices in the number of flights comprises operating a screw to advance the number of flights through the blancher.
